(19) United States
(12) Patent Application Publication
(10) Pub. No.: US 2026/0273991 A1
(43) Pub. Date: Sep. 17, 2026

(54) HEAT ERASABLE ERASER

(71) Applicant: Guangzhou Youxiang Cultural Supplies Co.,Ltd, Guangzhou (CN)

(72) Inventors: Xiongliang XIAO, Guangzhou (CN); Ge LIN, Guangzhou (CN)

(73) Assignee: Guangzhou Youxiang Cultural Supplies Co.,Ltd, Guangzhou (CN)

(21) Appl. No.: 19/448,143

(22) Filed: Jan. 14, 2026

(30) Foreign Application Priority Data
Mar. 13, 2025 (CN) 202520447949X

(51) Int. Cl. B43L 19/00

(52) U.S. Cl. CPC B43L 19/00

(57) ABSTRACT

Disclosed is a heat erasable eraser, including a housing (1); a heat erasing assembly (2), connected to the housing (1), where the heat erasing assembly (2) includes a heat erasing head (21); and a protective cover (3), movably connected to the housing (1) or the heat erasing assembly (2), where the protective cover (3) is operated to enable the heat erasing head (21) to be optionally exposed outside the protective cover (3) or covered by the protective cover (3). In the heat erasable eraser of this disclosure, by disposing the movable protective cover, the heat erasing head is exposed outside the housing when needed and covered by the protective cover when not needed, so that a user can be effectively prevented from being accidentally burnt by the heat erasing head, thereby improving the safety performance of the product.

### CROSS-REFERENCE TO RELATED APPLICATIONS

The application claims priority to Chinese patent application No. 202520447949X, filed on Mar. 13, 2025, the entire contents of which are incorporated herein by reference.

### TECHNICAL FIELD

This disclosure relates to the field of stationery, and specifically to a heat erasable eraser.

### BACKGROUND

With the advancement of technology, ink that can be heated to erase handwriting has been invented. The handwriting written with this type of ink can be erased by heating. Currently, there are two common erasing methods. One involves using silicone rubber to rub back and forth on the handwriting by hand, which can easily damage the paper and often leaves residue. The other uses an electric heating head, but the exposed electric heating head can easily cause accidental skin burns.

Therefore, it is necessary to provide a heat erasable eraser with higher safety.

### SUMMARY

To achieve the above purpose, this disclosure provides the following technical solution:

A heat erasable eraser, including a housing 1; a heat erasing assembly 2, connected to the housing 1, where the heat erasing assembly 2 includes a heat erasing head 21; and a protective cover 3, movably connected to the housing 1 or the heat erasing assembly 2, where the protective cover 3 is operated to enable the heat erasing head 21 to be optionally exposed outside the protective cover 3 or covered by the protective cover 3.

Further, a function key 4 is further included and is movably connected to the housing 1; the protective cover 3 is slidably connected to the housing 1 or the heat erasing assembly 2; the protective cover 3 is operated through the function key 4, which can enable the protective cover 3 to move toward a direction away from the heat erasing head 21 and enable the heat erasing head 21 to be exposed outside the protective cover 3.

Further, the heat erasing assembly 2 further includes a power supply module 23 and a triggering switch 24 electrically connected to the power supply module 23; the heat erasing head 21 is electrically connected to the power supply module 23 and the triggering switch 24; and an action of operating the function key 4 to enable the protective cover 3 to move can trigger the triggering switch 24 in a linked manner, thereby enabling the heat erasing head 21 to heat up.

Further, the triggering switch 24 is located on a movement path of the protective cover 3 or located on an activity path of the function key 4, thereby triggering the triggering switch 24 during the action of operating the function key 4 to enable the heat erasing assembly 2 to move.

Further, the function key 4 is slidably connected to the housing 1; the triggering switch 24 is located at a tail end of a sliding stroke of the function key 4; and the function key 4 is pressed toward the inside of the housing 1, which can enable the protective cover 3 to move, and during the movement of the function key 4, the triggering switch 24 is triggered.

Further, the function key 4 is provided with a guide surface 41 located at one end close to the inside of the housing 1; and the protective cover 3 is provided with a matching guide surface 33.

Further, an outer side wall of the housing 1 is provided with a clearance groove 12; and the function key 4 is mounted in the clearance groove 12, and an initial height of the function key 4 does not exceed a highest point of the clearance groove 12.

Further, a reset member 5 is further included, which is connected between the protective cover 3 and the housing 1 and is suitable for enabling the protective cover 3 to have a tendency of moving toward the outside of the housing 1.

Further, the housing 1 is provided with an accommodation cavity 11, and the accommodation cavity 11 is provided with an opening 111; the heat erasing assembly 2 is fixed in the accommodation cavity 11, and the heat erasing head 21 is at least partially exposed outside the opening 111; and the protective cover 3 is slidably connected to the accommodation cavity 11.

Further, the protective cover 3 includes: a cover body portion 31, suitable for covering the heat erasing head 21; and a mounting portion 32, connected to a rear end of the cover body portion 31 and suitable for matching the function key 4.

In the heat erasable eraser of this disclosure, by disposing the movable protective cover, the heat erasing head is exposed outside the housing when needed and covered by the protective cover when not needed, so that a user can be effectively prevented from being accidentally burnt by the heat erasing head, thereby improving the safety performance of the product.

### BRIEF DESCRIPTION OF THE DRAWINGS

To describe the embodiments of this disclosure or the technical solutions in the prior art more clearly, the accompanying drawings used in the embodiments or the prior art will be briefly introduced below. It is obvious that the accompanying drawings in the following description are only some embodiments in this disclosure, and those of ordinary skill in the art may derive other accompanying drawings from these accompanying drawings without creative efforts.

FIG. 1 is a schematic structural diagram of a heat erasable eraser disclosed in Embodiment 1 of this disclosure;

FIG. 2 is a schematic internal structural diagram of a structure in FIG. 1 when opened;

FIG. 3 is a schematic structural diagram of a heat erasable eraser in FIG. 1 when a function key is pressed;

FIG. 4 is a schematic internal structural diagram of a structure in FIG. 3 when opened;

FIG. 5 is a schematic structural sectional view of a structure in FIG. 3;

FIG. 6 is a schematic structural exploded view of a heat erasable eraser in Embodiment 1; and

FIG. 7 is a schematic structural diagram of a function key and a protective cover.

### REFERENCE NUMERALS IN THE ACCOMPANYING DRAWINGS

1. housing; 11. accommodation cavity; 111. opening; 12. clearance groove;

2. heat erasing assembly; 21. heat erasing head; 211. head cap; 212. electric heating wire; 22. mounting frame;23. power supply module; 24. triggering switch;

3. protective cover; 31. cover body portion; 32. mounting portion; 33. matching guide surface;

4. function key; 41. guide surface;

5. reset member.

### DETAILED DESCRIPTION OF THE EMBODIMENTS

To make the purposes, technical solutions, and advantages of this disclosure clearer, the following clearly and completely describes the technical solutions of this disclosure in conjunction with the embodiments and the accompanying drawings. It should be noted that the embodiments described below with reference to the accompanying drawings are exemplary and are intended to explain this disclosure, but should not be construed as a limitation on this disclosure.

For example, the terms “first” and “second” are intended only for descriptive purposes and should not be construed as indicating or implying their relative importance or implicitly indicating the quantity of technical features indicated. Therefore, features defined by “first” and “second” can explicitly or implicitly include at least one of such features; and “a plurality of” refers to at least two, for example, two or three, unless otherwise expressly and specifically defined.

The terms “mounted”, “attached”, “connected”, “fixed”, and the like should be understood in a broad sense, for example, it may be a fixed connection, a detachable connection, or an integral connection; it may be a mechanical connection or an electrical connection; it may be a direct connection or an indirect connection via an intermediate medium; and it may be a communication within two elements or an interaction between two elements, unless otherwise expressly defined.

The orientations or positional relationships indicated by the terms “center”, “longitudinal”, “transverse”, “length”, “width”, “thickness”, “up”, “down”, “front”, “rear”, “left”, “right”, “vertical”, “horizontal”, “top”, “bottom”, “inside”, “outside”, “clockwise”, “counter-clockwise”, “axial”, “radial”, “circumferential”, and the like are in accordance with those shown in the accompanying drawings and intended only for the convenience of describing the technical solutions of this disclosure rather than for indicating or implying that the referred device or element must be provided with a particular orientation or constructed and operated in a particular orientation. For example, a first feature being “above” or “below” a second feature may indicate a direct contact between the first and second features or an indirect contact between the first and second features through an intermediate medium; a first feature being “above”, “over”, or “on” a second feature may indicate that the first feature is directly or diagonally above the second feature, or only indicate that the first feature is higher in level than the second feature; and a first feature being “below”, “beneath” or “under” a second feature may indicate that the first feature is directly or diagonally beneath the second feature, or only indicate that the first feature is lower in level than the second feature.

### Embodiment 1

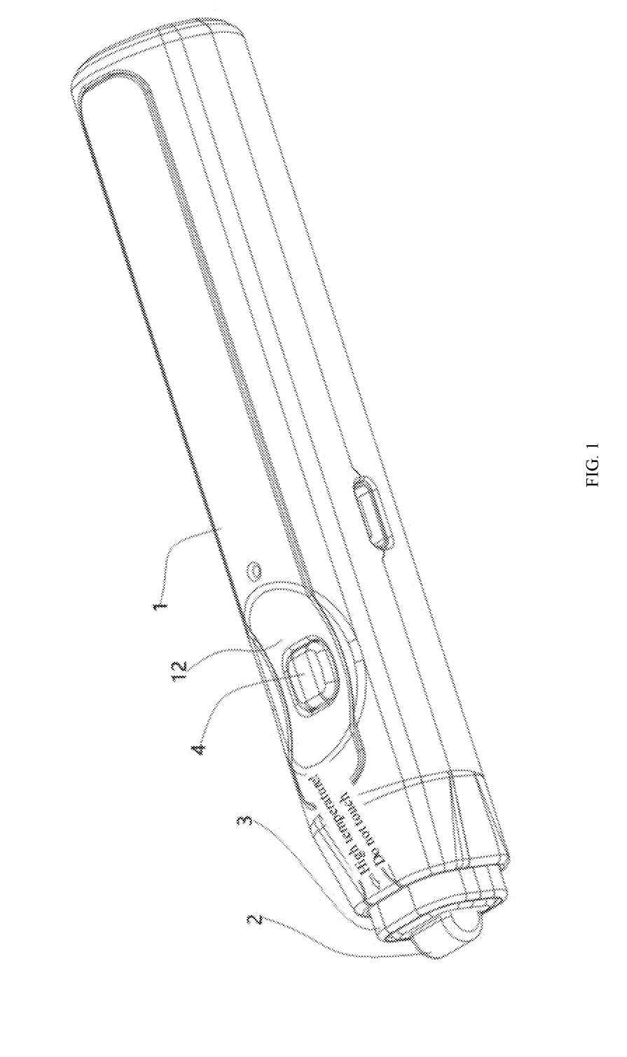

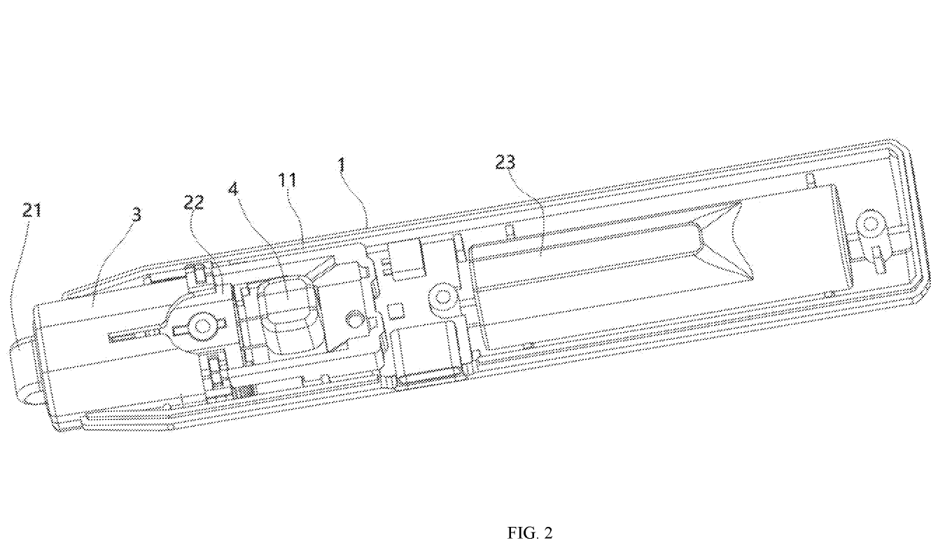

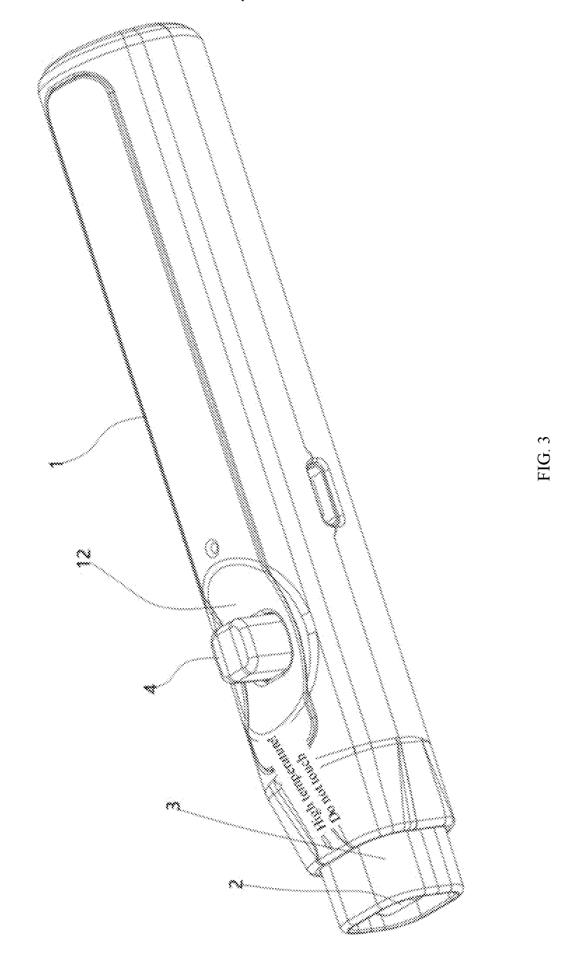

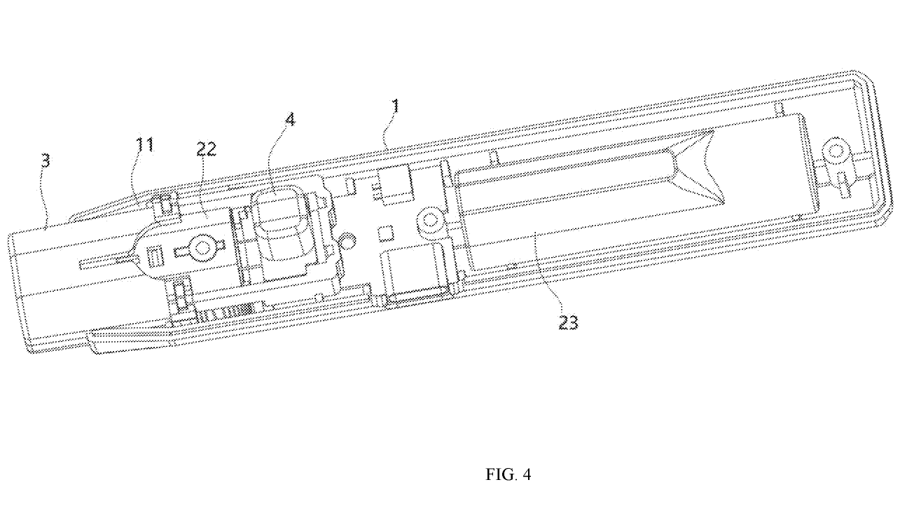

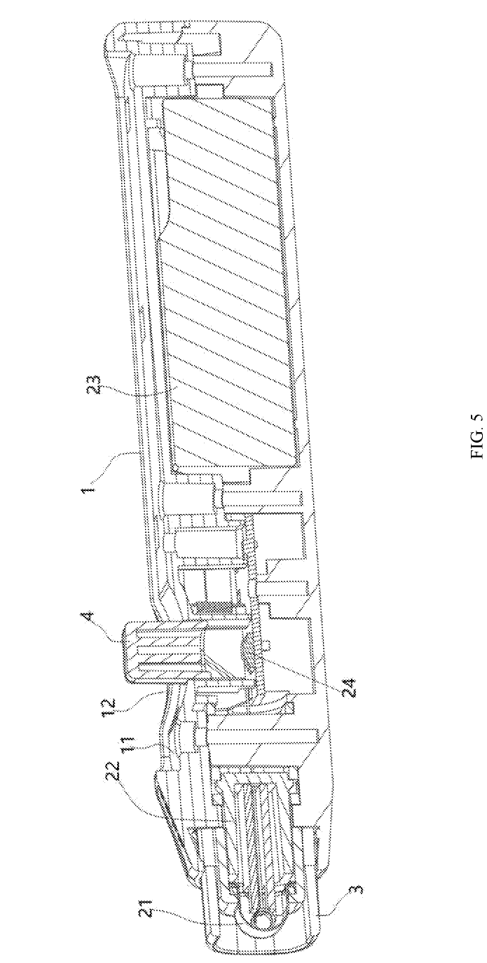

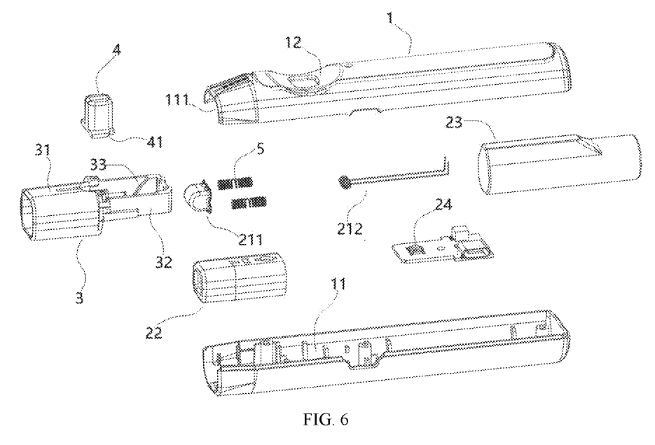

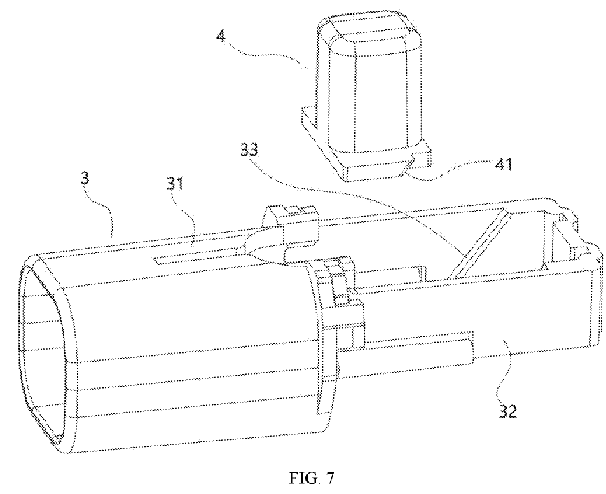

As shown in FIG. 1 to FIG. 7, this disclosure provides a preferred embodiment of a heat erasable eraser, including a housing 1; a heat erasing assembly 2, connected to the housing 1, where the heat erasing assembly 2 includes a heat erasing head 21; and a protective cover 3, movably connected to the housing 1 or the heat erasing assembly 2, where the protective cover 3 is operated to enable the heat erasing head 21 to be optionally exposed outside the protective cover 3 or covered by the protective cover 3, so that a user can be effectively prevented from being accidentally burnt by the heat erasing head 21, thereby improving the safety performance of the product.

In this embodiment, an example where the protective cover 3 is slidably connected to the housing 1 and the protective cover 3 is operated through a function key 4 is used for exemplary description.

Specifically, the housing 1 is provided with an accommodation cavity 11, and the accommodation cavity 11 is provided with an opening 111; the heat erasing assembly 2 is fixed in the accommodation cavity 11, and the heat erasing head 21 is at least partially exposed outside the opening 111; and the protective cover 3 is slidably connected to the accommodation cavity 11. In some embodiments, the protective cover 3 may also be slidably disposed on an outer wall of the housing 1 and is located on an outer side of the opening 111 of the accommodation cavity 11.

The heat erasing assembly 2 includes the heat erasing head 21 and a mounting frame 22 and is fixedly connected in the accommodation cavity 11 through the mounting frame 22. It is easily understood that in some other embodiments, the protective cover 3 may also be slidably connected to the mounting frame 22.

The protective cover 3 includes: a cover body portion 31, suitable for covering the heat erasing head 21; and a mounting portion 32, connected to a rear end of the cover body portion 31 and suitable for matching the function key 4. In this embodiment, the cover body portion 31 is sleeved on an outer side of the mounting frame 22, the heat erasing head 21 is at one end of the mounting frame 22, and the function key 4 enables the cover body portion 31 to optionally cover the heat erasing head 21 or enable the heat erasing head to be exposed outside the cover body portion 31.

Further, the function key 4 is further included and is movably connected to the housing 1; the protective cover 3 is slidably connected to the housing 1; the protective cover 3 is operated through the function key 4, which can enable the protective cover 3 to move toward a direction away from the heat erasing head 21 and enable the heat erasing head 21 to be exposed outside the protective cover 3. It is easily understood that in some embodiments with poor effects, the protective cover 3 can be directly operated to enable the heat erasing head 21 to be exposed or covered.

The function key 4 is provided with a guide surface 41 located at one end close to the inside of the housing 1; the protective cover 3 is provided with a matching guide surface 33 that is specifically disposed on the mounting portion 32; and the guide surface 41 and the matching guide surface 33 jointly act to prompt the protective cover 3 to move toward the inside of the housing 1 in a process of pressing the function key 4, thereby exposing the heat erasing head 21 to the outside.

The heat erasing assembly 2 further includes a power supply module 23 and a triggering switch 24 electrically connected to the power supply module 2; and the heat erasing head 21 is electrically connected to the power supply module 23 and the triggering switch 24.

Further, an action of operating the function key 4 to enable the protective cover 3 to move can trigger the triggering switch 24 in a linked manner, thereby enabling the heat erasing head 21 to heat up and further improving the safety performance of the product. In addition, when the heat erasable eraser is not needed, the heat erasing head 21 does not consume the power of the power supply module 23, which can effectively improve the endurance of the product.

The triggering switch 24 is disposed on a sliding path of the protective cover 3 or on an activity path of the function key 4, thereby triggering the triggering switch 24 during the action of operating the function key 4 to enable the heat erasing assembly 2 to move.

For example, in this embodiment, the function key 4 is slidably connected to the housing 1. The triggering switch 24 is located at a tail end of a sliding stroke of the function key 4, that is, the triggering switch 24 is located below the function key 4. The function key 4 is pressed toward the inside of the housing 1, which can enable the protective cover 3 to move, and when the function key 4 reaches the tail end of the stroke, the triggering switch 24 is triggered, and the power supply module 23 enables the heat erasing head to heat up. For another example, the triggering switch 24 is located on the sliding stroke of the function key 4 and on a side of the function key 4; and a protruding block is disposed on the function key 4, so that the triggering switch 24 is triggered in the process of pressing the function key 4.

In this embodiment, the triggering switch 24 is a normally open switch, and the switch is closed by touching the function key 4, thereby forming a circuit path between the power supply module 23 and the heat erasing head 21 to heat the heat erasing head 21. It is not difficult to understand that in some other embodiments, a normally closed switch may also be used and is disposed on an initial segment of the sliding stroke of the function key 4 or the protective cover 3. After the function key 4 is pressed, a touch protrusion of the function key 4 or the protective cover 3 is released from the normally closed switch, thereby forming the circuit path between the power supply module 23 and the heat erasing head 21.

The heat erasing head 21 includes an electric heating wire 212 and a head cap 211. The head cap 211 is fixed on the mounting frame 22, and the electric heating wire 212 is electrically connected to the triggering switch 24 and a power supply assembly respectively. In addition, the electric heating wire 212 extends into a cavity of the head cap 211.

Further, a reset member 5 is further included, which is connected between the protective cover 3 and the housing 1 and is suitable for enabling the protective cover 3 to have a tendency of moving toward the outside of the housing 1. The reset member 5 is preferably a spring, with two ends abutting against the cover body portion 31 of the protective cover 3 and an inner wall of the accommodation cavity 11 of the housing 1 respectively.

In this embodiment, after an external force of pressing the function key 4 is canceled, the reset member 5 pushes the protective cover 3 toward a direction of the opening 111 of the accommodation cavity 11. At the same time, under the joint action of the matching guide surface and the guide surface 41, the function key 4 is pushed toward the outside of the housing 1, to be away from the triggering switch 24. At the same time, the heat erasing head 21 and the power supply module 23 are disconnected and no longer generate heat.

Further, an outer side wall of the housing 1 is provided with a clearance groove 12; and the function key 4 is mounted in the clearance groove 12, and an initial height of the function key 4 does not exceed a highest point of the clearance groove 12. One of the purposes is to prevent the function key 4 from being accidentally touched. Specifically, the bottom of the clearance groove 12 is provided with a mounting hole, and the function key 4 is slidably disposed in the mounting hole.

### Working principles

When in use, the function key 4 is pressed; the guide surface 41 of the function key 4 squeezes the matching guide surface 33 of the protective cover 3, to enable the protective cover 3 to continuously slidably retract into the accommodation cavity 11 of the housing 1; and when the function key 4 reaches the tail end of its stroke, the triggering switch 24 is triggered, and the power supply module 23 enables the heat erasing head 21 to heat up, and at the same time, the protective cover 3 retracts into the accommodation cavity 11, to enable the heat erasing head 21 to be exposed.

When the heat erasable eraser is not needed, the external force of pressing the function key 4 is canceled, and the reset member 5 pushes the protective cover 3 toward the direction of the opening 111 of the accommodation cavity 11. At the same time, under the joint action of the matching guide surface and the guide surface 41, the function key 4 is pushed toward the outside of the housing 1, to be away from the triggering switch 24. At the same time, the heat erasing head 21 and the power supply module 23 are disconnected and no longer generate heat until the protective cover 3 and the function key 4 return to initial positions, and the heat erasing head 21 also returns to an initial state of being covered by the protective cover 3.

### Embodiment 2

As a variation of Embodiment 1, the above action of operating the function key 4 to enable the protective cover 3 to move can trigger the triggering switch 24 in a linked manner, and the protective cover 3 triggers the triggering switch 24.

Specifically, the protective cover 3 is slidably connected to the accommodation cavity 11 of the housing 1. The triggering switch 24 is located at a tail end of a sliding stroke of the protective cover 3, that is, the triggering switch 24 is located behind the protective cover 3. The function key 4 is pressed toward the inside of the housing 1, which can enable the protective cover 3 to move, and when the protective cover 3 reaches the tail end of the stroke, the triggering switch 24 is triggered, and the power supply module 23 enables the heat erasing head to heat up. Alternatively, the triggering switch 24 is located on the sliding stroke of the protective cover 3 and on a side of the protective cover 3, and the protruding block is disposed on the function key 4, thereby triggering the triggering switch 24 in the process of pressing the function key 4.

### Embodiment 3

As a variation of Embodiment 1, the above function key 4 includes a pushing plate and a connecting plate.

Specifically, the housing 1 is provided with a sliding groove, and the pushing plate is fixedly connected to the protective cover 3 after passing through the sliding groove through the connecting plate. When in use, the pushing plate is pushed to drive the protective cover 3 to move toward a direction away from the heat erasing head 21, thereby exposing the heat erasing head 21 to the outside.

It may be understood that the above triggering switch 24 is disposed on the sliding stroke of the connecting plate or the protective cover 3, so that the action of operating the function key 4 to enable the protective cover 3 to move is linked to the action of triggering the triggering switch 24, thereby further improving the mounting performance and endurance of the product.

### Embodiment 4

As another embodiment, the above protective cover 3 is replaced by a flip-cap design instead of being slidably connected to the housing 1.

Specifically, one end of the protective cover 3 is hinged to the housing 1 through a rotating shaft, and the other end of the protective cover 3 is rotated, to flip open the protective cover 3, thereby enabling the heat erasing head 21 to be exposed.

In the heat erasable eraser of this disclosure, by disposing the movable protective cover, the heat erasing head is exposed outside the housing when needed and covered by the protective cover when not needed, so that a user can be effectively prevented from being accidentally burnt by the heat erasing head, thereby improving the safety performance of the product.

The above embodiments only express a part of the implementations of this disclosure. Any variations, substitutions, and improvements made by those skilled in the art without departing from the concept of this disclosure, without creative efforts, shall all fall within the protection scope of this disclosure.

What is claimed is:

1. A heat erasable eraser, comprising a housing (1);
a heat erasing assembly (2), connected to the housing (1), wherein the heat erasing assembly (2) comprises a heat erasing head (21); and
a protective cover (3), movably connected to the housing (1) or the heat erasing assembly (2), wherein
the protective cover (3) is operated to enable the heat erasing head (21) to be optionally exposed outside the protective cover (3) or covered by the protective cover (3).

2. The heat erasable eraser according to claim 1, further comprising a function key (4), movably connected to the housing (1), wherein
the protective cover (3) is slidably connected to the housing (1) or the heat erasing assembly (2); and
the protective cover (3) is operated through the function key (4), which can enable the protective cover (3) to move toward a direction away from the heat erasing head (21) and enable the heat erasing head (21) to be exposed outside the protective cover (3).

3. The heat erasable eraser according to claim 2, wherein the heat erasing assembly (2) further comprises a power supply module (23) and a triggering switch (24) electrically connected to the power supply module (23);
the heat erasing head (21) is electrically connected to the power supply module (23) and the triggering switch (24); and
an action of operating the function key (4) to enable the protective cover (3) to move can trigger the triggering switch (24) in a linked manner, thereby enabling the heat erasing head (21) to heat up.

4. The heat erasable eraser according to claim 3, wherein the triggering switch (24) is located on a movement path of the protective cover (3) or located on an activity path of the function key (4), thereby triggering the triggering switch (24) during the action of operating the function key (4) to enable the heat erasing assembly (2) to move.

5. The heat erasable eraser according to claim 3, wherein the function key (4) is slidably connected to the housing (1);
the triggering switch (24) is located at a tail end of a sliding stroke of the function key (4); and
the function key (4) is pressed toward the inside of the housing (1), which can enable the protective cover (3) to move, and during the movement of the function key (4), the triggering switch (24) is triggered.

6. The heat erasable eraser according to claim 5, wherein the function key (4) is provided with a guide surface (41) located at one end close to the inside of the housing (1); and
the protective cover (3) is provided with a matching guide surface (33).

7. The heat erasable eraser according to claim 5, wherein an outer side wall of the housing (1) is provided with a clearance groove (12); and
the function key (4) is mounted in the clearance groove (12), and an initial height of the function key (4) does not exceed a highest point of the clearance groove (12).

8. The heat erasable eraser according to claim 5, further comprising a reset member (5), connected between the protective cover (3) and the housing (1) and suitable for enabling the protective cover (3) to have a tendency of moving toward the outside of the housing (1).

9. The heat erasable eraser according to claim 8, wherein the housing (1) is provided with an accommodation cavity (11), and the accommodation cavity (11) is provided with an opening (111);
the heat erasing assembly (2) is fixed in the accommodation cavity (11), and the heat erasing head (21) is at least partially exposed outside the opening (111); and
the protective cover (3) is slidably connected to the accommodation cavity (11).

10. The heat erasable eraser according to claim 9, wherein the protective cover (3) comprises: a cover body portion (31), suitable for covering the heat erasing head (21); and
a mounting portion (32), connected to a rear end of the cover body portion (31) and suitable for matching the function key (4).
